(19) United States
(12) Patent Application Publication
(10) Pub. No.: US 2010/0101145 A1
(43) Pub. Date: Apr. 29, 2010

(54) HYDROPONIC SYSTEM

(75) Inventor: Klaes Alexander Bergen, Bagsvaerd (DK)

Correspondence Address: SUGHRUE MION, PLLC, 2100 PENNSYLVANIA AVENUE, N.W., SUITE 800, WASHINGTON, DC, 20037, US

(73) Assignee: CROPTIMIZE APS, Bagswerd (DK)

(21) Appl. No.: 12/595,016

(22) PCT Filed: Apr. 10, 2008
(86) PCT No.: PCT/DK2008/050082

§ 371 Date: Jan. 4, 2010

(30) Foreign Application Priority Data
Apr. 10, 2007 (DK) PA 2007 00529

(51) Int. Cl. A01G 31/06

(52) U.S. Cl. 47/59 S; 47/62 R

(57) ABSTRACT

A hydroponic system comprising an upper panel adapted to carry plants to be grown in said hydroponic system, a lower panel arranged below said upper panel to form a space between said panels such as to allow for roots of said plants to extend through said upper panel into said space. Said panels each comprise a downwardly inclined panel surface, and a nutrient solution dispenser arranged such as to allow for distribution of a nutrient solution between said upper and lower panels. Said panel surfaces are of such a shape that at least three, preferably at least four, tangential planes to each said panel surfaces can be defined, none of said tangential planes of each panel surface being parallel or coincident.

The present invention relates in a first aspect to a hydroponic system comprising an upper panel adapted to carry plants to be grown in said hydroponic system, a lower panel arranged below said upper panel to form a space between said panels such as to allow for roots of said plants to extend through said upper panel into said space, said panels each comprising an oblique panel surface inclined downward from an apex or ridge, and a nutrient solution dispenser arranged such as to allow for distribution of a nutrient solution between said upper and lower panels.

Hydroponics is a method of growing plants using mineral nutrient solutions instead of soil. Terrestrial plants may be grown with their roots in the mineral nutrient solution only or in an inert medium, such as perlite, gravel or mineral wool. When the required mineral nutrients are introduced into a plant's water supply artificially, soil is no longer required for the plant to thrive. Hydroponics is often the best existing crop production method, i.e. the method with the highest yield per area unit, in areas that lack suitable soil, such as Greenland.

With hydroponics high quality foods can be grown anywhere in the world, regardless of temperature and growing seasons. Many other advantages are known to be connected to hydroponics, e.g. fewer weeds, energy savings, elimination of soil borne diseases and fewer requirements for pesticides. Hydroponics also to a large amount saves water.

The two main types of hydroponics are solution culture and medium culture. Solution culture does not use a solid medium for the roots, just the nutrient solution. The three main types of solution culture are static solution culture, continuous flow solution culture and aeroponics. The medium culture method has a solid medium for the roots and is named for the type of medium, e.g. sand culture, gravel culture or Rockwool culture, perlite culture, expanded clay culture etc.

In continuous flow solution culture the nutrient solution constantly flows past the roots. A popular variation is the nutrient film technique or NFT whereby a very shallow stream of water containing the dissolved nutrients required for plant growth is recirculated past the bare roots of plants in a watertight gully, also known as channels.

Aeroponics is a system where roots are continuously or discontinuously in an environment saturated with fine drops (a mist or aerosol), e.g. by means of ultrasound atomization of nutrient solution. The method requires no substrate and entails growing plants with their roots suspended in a deep air or growth chamber with the roots periodically wetted with a fine mist of atomized nutrients.

JP 2000316401 discloses a hydroponic system according to the introduction in which two flat outer panel parts have been assembled to form an upper panel with an inverted V-shape. The upper panel extends in a longitudinal direction and plants grow on the upper surface of the upper panel. Below the outer panel a similarly shaped and sized lower panel is positioned, the roots of the plants extending into a space defined between the panels. A spraying tube is positioned between ridges of the panels for spraying a nutrient solution over the roots of the plants. A downwardly inclined panel surface is provided for the upper panel, the panel surface forming an inverted V-shape. One plane panel surface part is defined on each leg of the V-shape, and a tangential plane can be defined in relation to each of the said two panel surface parts, each tangential plane being plane with the respective panel surface part.

U.S. Pat. No. 6,000,173 discloses a hydroponic system with similarly shaped and positioned panels, in which a nutrient solution runs from a tube positioned between the ridges of the panels. The nutrient solution runs down the inner panel via gravitational forces, thus providing nutrients to plant roots resting on the lower panel.

Harvesting of the inverted V-shapes of the upper panels of JP 2000316401 and U.S. Pat. No. 6,000,173 is carried out manually: a harvesting person walks down an aisle defined between two panels arranged in parallel, manually collecting the plants on either side of him. The plants are typically grown in individual pots, the harvesting person collecting the pots before harvesting the plants.

It is the object of the invention to provide a hydroponic system with increased yield in relation to the prior art systems as well as increased efficiency during harvesting.

To meet this object the hydroponic system according to the first aspect of the invention is characterized in that each of said panel surfaces is of such a shape that at least three, preferably at least four, tangential planes to each said panel surface can be defined, none of said tangential planes of each panel surface being parallel or coincident.

Providing panel surfaces with shapes such that at least three tangential planes to each said panel surface can be defined provides an improved utilization of a given available floor space in relation to systems in which only two tangential planes can be defined. Thus, the area available for holding plants is significantly increased.

This advantage is due to recognition by the inventor of the present invention that using the harvesting method according to the second aspect of the invention it is not necessary to be able to gain access to the upper panel surface from harvesting aisles between hydroponic systems positioned side-by-side. Thus, a more optimal utilization of the available floor area is made possible since more complex geometric shapes of the panels, such as pyramid-shaped or cone-shaped panels, can be applied. Since a larger plant area is available per floor area unit, a larger yield of the harvest is achieved.

In a preferred embodiment of the first aspect of the invention said tangential planes can be defined such that all angles between the individual planes are at least 15°, preferably at least 25°, most preferred at least 35°.

In another preferred embodiment each said panel surface comprises four sides, lower edges of said four sides preferably forming a quadratic bottom plane. This feature allows for more hydroponic systems to be positioned optimally side-by-side, providing a better utilization of the available floor area. In a further development of this embodiment said four sides and bottom plane form a pyramid shape, an angle between each side in relation to said bottom plane preferably being within an interval of 10-50°, most preferred 30-40°. These angle intervals have proven to form an optimal compromise between floor area exploitation, nutrient circulation, securing the plants in the desired positions and nutrient absorption in the plants. A large angle provides better circulation of aeroponically distributed nutrients while a small angle secures the plants better on the upper panel. A too powerful flow of nutrient solution involves problems with nutrient absorption in the plants; a too weak flow entails nutrient solution stagnation and plant anoxia on the lower panel. With pyramid-shaped panels having an angle of 45° in relation to a horizontal bottom plane the available area for plants on the upper panel is increased with about 40% in relation to a flat upper panel.

In another preferred embodiment said upper and lower panels are of substantially similar shape and size and arranged such that said space between said panels is of a substantially constant height.

In another preferred embodiment said upper panel is in the form of a plate with holes or a net, a hole or mesh size preferably being below 50 mm, more preferably below 20 mm. Hereby, use of potholes can be avoided because the plants can be allowed to grow in a generally distributed layer of medium. This significantly increases the area available for the plants and thereby crop yield. In a further development of this embodiment said upper panel comprises a number of irregularities, such as steps or corrugations, adapted to provide frictional resistance of a grainy medium to be positioned on said upper panel to carry said plants. This feature is advantageous using a loose medium such as gravel because it contributes to maintain the medium evenly distributed over the upper panel surface. Thus, in another preferred embodiment a medium, preferably an inert medium such as perlite, gravel or mineral wool, has been distributed over said upper panel.

In another preferred embodiment said hydroponic system is arranged side-by-side with a number of similar hydroponic systems according to any of the above embodiments to form a hydroponic plant. Hereby, a given floor area can be optimally utilized.

In a second aspect the invention provides a method for harvesting of a hydroponic system, comprising the steps of:

providing a hydroponic system comprising a removable upper panel carrying plants to be harvested, a lower panel arranged below said upper panel to form a space between said panels, roots of said plants extending through said upper panel into said space,

removing said upper panel including said plants to be harvested from said hydroponic system,

transporting said upper panel to a harvesting location, and

cutting off said roots of said plants such that said plants are released from said upper panel, thereby harvesting said plants.

With the method according to the second aspect of the invention it is possible to position hydroponic systems side-by-side without providing a harvesting aisle between them. The upper panel can be removed using for instance an arm with a chain drive, which may engage a chain or lug of the upper panel in order to lift it from the remaining part of the hydroponic system. Subsequently, the upper panel is trans-ported to a harvest location, which may be in the form of central harvesting machinery comprising automatic means for cutting off the roots of the plants from the bottom surface of the upper panel. The root cutting can be easily carried out by means of one large knife guided along the lower side of the upper panel. Hereby, the plants are cut loose from the upper panel and can be collected.

The method thus provides a very efficient harvesting process, which can be continuously carried out on several hydroponic systems according to the first aspect of the invention positioned side-by-side in close proximity of each other. The method can be mechanized to a large extent; both removal and transport of the upper panel as well as the harvesting step can be completely mechanized and automated. Pots and potholes can also be avoided because the root cutting step makes collecting pots during harvesting superfluous. Thus, a higher yield and a more efficient harvesting is achieved.

In a preferred embodiment of the second aspect of the invention the method is for harvesting a hydroponic system according to any of the above embodiments.

In a third aspect the invention provides a hydroponic system comprising

an upper panel adapted to carry plants to be grown in said hydroponic system, a lower panel arranged below said upper panel to form a space between said panels such as to allow for roots of said plants to extend through said upper panel into said space, said panels each comprising a downwardly inclined panel surface, and

a nutrient solution dispenser arranged such as to allow for distribution of a nutrient solution between said upper and lower panels,

characterized by

comprising means for aeroponic distribution of said nutrient solution in said space between said panels and means for continuous flow of said nutrient solution on an upper surface of said lower panel.

Providing both aeroponic and continuous flow distribution of a nutrient solution has the surprising advantage that the aeroponically distributed nutrient solution is circulated much better than in cases in which continuous flow distribution is not implemented. The cause of this is believed to arise from the continuous flowing solution exerting frictional forces on gases and aerosols between the two panels. The frictional forces are believed to force particles near the flowing solution downward, thus creating eddies in the space between the panels. Since roots in this space are more exposed to the aeroponically distributed nutrient solution, higher yield is achieved. Also, referring to the discussion above regarding the problems relating to nutrient absorption in the plants with too powerful flow of nutrient solution, the combination of aeroponic and continuous flow distribution allows for a larger angle of the lower panel surface than would otherwise be feasible.

In a preferred embodiment of the third aspect of the invention said lower panel at an apex comprises an opening with a vessel to be filled with said nutrient solution, an atomizer, preferably ultrasound-driven, being positioned within said vessel allowing for aeroponic distribution of said nutrient solution in said space between said panels, preferably said vessel is arranged to also allow for continuous flow of said nutrient solution on an upper surface of said lower panel by means of overflow of said vessel. This provides an efficient and well-working low-cost way of providing both aeroponic and continuous flow distribution of a nutrient solution.

In another preferred embodiment said system is according to any of the embodiments of the first aspect of the invention.

The invention will be explained in detail in the following by means of examples of embodiments with reference to the schematic drawing, in which

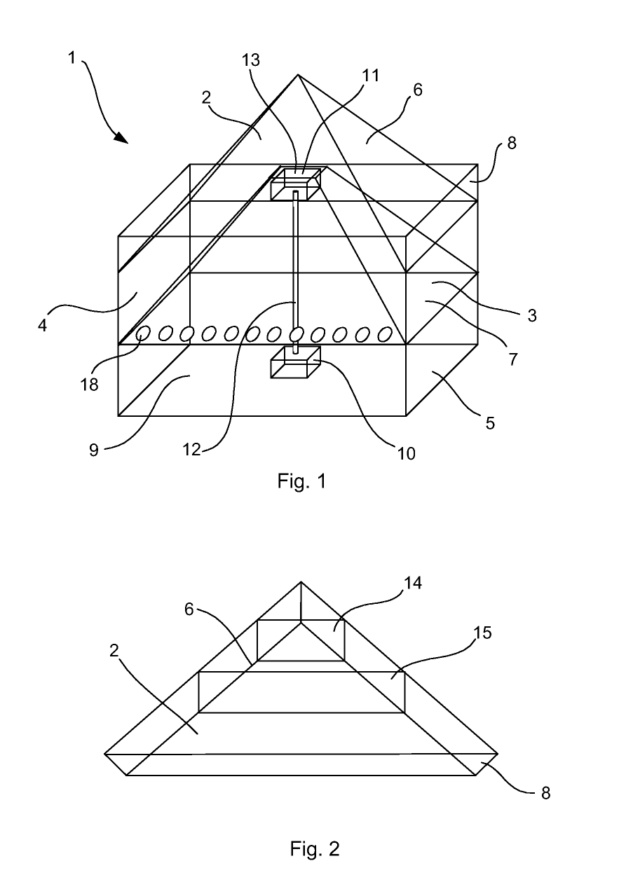

FIG. 1 is a perspective view of an embodiment of a hydroponic system according to the first and third aspects of the present invention,

FIG. 2 is a side view of an alternative embodiment of an upper panel of a hydroponic system according to the first and third aspects of the invention,

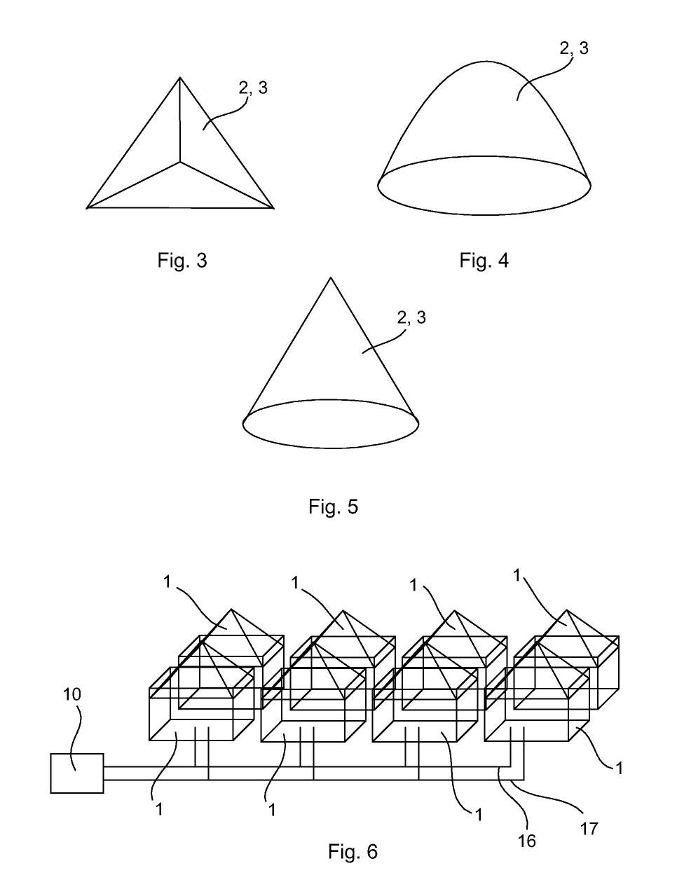

FIGS. 3-5 are perspective views of alternative shapes of panels of a hydroponic system according to the first and third aspects of the invention, and

FIG. 6 is a perspective view of a hydroponic plant comprising a number of hydroponic systems according to the one shown in FIG. 1.

Throughout the drawings like reference signs in different embodiments refer to like elements or elements of the same function.

FIG. 1 shows an embodiment of a hydroponic system 1 according to the first and third aspects of the present invention. The hydroponic system 1 comprises an upper panel 2 adapted to carry the plants (not shown) to be grown in the hydroponic system 1. A lower panel 3 is arranged below the upper panel 1 defining a space 4 between the panels 2, 3 such as to allow for roots of the plants to extend through the upper panel 2 into the space 4. The panels 2, 3 are arranged in a box 5, the bottom sides of each panel 2, 3 abutting inner surfaces of the box 5. The box 5 comprises four side plates and a bottom plate and is provided with an open top. The dimensions of the hydroponic system 1 are about 1×1×1 m, the enclosed volume being about 1 m³. The system according to the invention can in principle be of any other suitable size. The box 5 and panels 2, 3 are preferably manufactured from plastic, but other materials can be used, including glass, glass fiber, metal and wood.

The panels 2, 3 are of substantially similar shape and size and are arranged such that the space 4 between them is of a substantially constant height. The position of the upper panel 2 and thus the height is adjustable in order to customize the hydroponic system 1 to fit different desired root lengths or plants with different root length demands.

Each panel 2, 3 is pyramid-shaped and comprises four similar plane and triangular panel plates. The bottom sides of the four triangles define an imaginary quadratic bottom plane. An angle between each panel plate in relation to the imaginary bottom plane is about 35°. The respective four panel plates thus form oblique panel surfaces 6, 7 of the upper panel 2 and lower panel 3, respectively, inclined downward from an apex. Thus, each panel surface 6, 7 is of such a shape that four imaginary tangential planes to each said panel surface 6, 7 can be defined, none of said tangential planes being parallel or coincident. In the present case the four imaginary tangential planes are each coincident with one of the four panel plates.

Each of the triangular plates of the upper panel 2 has been cut out to a suitable plate shape from a net web, the plates being secured to each other at mutually abutting side surfaces of the triangular plates. The mesh size of the net is about 20 mm, allowing for roots of the plants to extend through the upper panel 2.

A growing medium (not shown) is positioned on the upper panel surface 6. The medium is preferably an inert medium such as perlite, gravel or mineral wool and has been distributed evenly over the upper panel 2. An upper part of the box 5 forms a retaining edge 8 for properly retaining the growing medium on the upper panel 2. In other embodiments the retaining edge is inclined outwards to be normal to the upper panel surface 6 to ensure a uniform height of the growing medium (cf. FIG. 2).

The lower panel 7 and the box 5 define a chamber 9. The chamber 9 encloses a dispensing system for dispensing of a nutrient solution between the upper and lower panels 2, 3. The nutrient solution comprises plant nutrients dissolved in water, preferably in inorganic and ionic form. The dispensing system comprises a solution pump 10, which conducts nutrient solution to a solution dispenser 11 via a solution conductor 12.

The lower panel 3 at the apex of the pyramid shape comprises an opening below which the solution dispenser 11 has been positioned. The solution dispenser 11 comprises a vessel 13 to be filled with nutrient solution by means of the solution conductor 12. It further comprises an ultrasound-driven atomizer positioned within the vessel 13 submerged in nutrient solution. The atomizer allows for aeroponic distribution of nutrient solution in the space 4. The vessel 13 is also arranged to allow for continuous flow (e.g. NFT distribution) of nutrient solution on the upper surface of the lower panel 3 by means of overflow of the vessel 13.

As previously mentioned, combination of aeroponic and continuous flow distribution has the advantage that the aeroponically distributed nutrient solution is circulated much better than in cases in which continuous flow distribution is not implemented. It is also possible to dispense with the usually necessary flow channels in the upper surface 7 of the lower panel 3 because the aeroponically distributed nutrient solution is able to reach areas, which the continuous flow distribution does not. Since channels can be avoided, risks of clogging the channels are also avoided. Also, the root space available is exploited better because more uniformly distributed roots of the plants are achieved.

However, the nutrient solution may be distributed in any other suitable way. For example dispensers, e.g. in the form of tubes with longitudinally distributed holes, may be provided along the joints between the panel plates of the lower panel 3 for sideward distribution of continuous flow on the upper surface of the lower panel 3. Alternatively, one or more nozzle systems can be implemented for aeroponic distribution and/or a drop watering system with a number of drop nozzles positioned for example at the lower surface of the upper panel 2 can be implemented.

To provide the plants with the light necessary for carrying out photosynthesis, LED lamps (not shown) are installed facing the upper surface 6 of the upper panel 2. Other lighting methods are also thinkable.

FIG. 2 shows an alternative embodiment of an upper panel 2 of a hydroponic system according to the first and second aspects of the invention. On each panel plate of the upper panel 2 a number of irregularities in the form of steps 14, 15 are provided. Each panel plate comprises two steps 14, 15 in the form of thin plates positioned vertically in order to provide frictional resistance of a growing medium positioned on the upper panel 2. The function of the steps 14, 15 thus corresponds to the function of the retaining edge 8, i.e. properly retaining the growing medium on the upper panel 2. In the present embodiment the retaining edge 8 is inclined outwards to be normal to the upper panel surface 6. The steps 14, 15 advantageously may be positioned to also be normal to the upper panel surface 6.

In other embodiments the steps 14, 15 can be replaced or supplemented by for example corrugations in the upper panel surface 6, a number of chambers or the like.

FIGS. 3-5 show three alternative shapes of the panels 2, 3 of a hydroponic system according to the first and second aspects of the invention. FIG. 3 shows an embodiment substantially corresponding to the pyramid-shaped panels 2, 3 of the embodiment of FIG. 1, but with three panel plates instead of four. In this embodiment the imaginary bottom plane defined by the lower sides of the three triangular panel plates is also triangular. FIGS. 4 and 5 show embodiments in which the panels 2, 3 are shaped like a hemisphere and a cone, respectively. Preferably, the panels 2, 3 are shaped to be provided with bottom sides allowing for a box 5 with linear side plates such as to allow for several hydroponic systems to be positioned optimally side-by-side.

In the embodiments of FIGS. 1 and 3-5 the panels 2, 3 comprise an oblique panel surface inclined downward from an apex or peak at the top of each panel. In other embodiments the panels may each instead comprise a ridge, i.e. a line forming the top of each panel. In this case, also, according to the invention each of said panel surfaces is of such a shape that at least three tangential planes to each said panel surface can be defined, none of said tangential planes of each panel surface being parallel or coincident.

The panels 2, 3 of the embodiment of FIG. 1 can be replaced with panels according to FIGS. 2-5. In the case of the embodiments of FIGS. 4 and 5 the box 5 can be correspondingly shaped, i.e. be circular, or preferably be linear.

In all embodiments the hydroponic system 1 can be in the form of a modular system to be assembled to form the hydroponic system 1. For example each panel 2, 3, the box 5 and the dispensing system can be provided as separate modular units to be assembled to form the hydroponic system 1.

FIG. 6 shows a hydroponic plant comprising a number of similar hydroponic systems 1 according to the embodiment of FIG. 1 arranged side-by-side in close proximity of each other. The sides of the bottom surfaces of each system 1 face each other and may abut each other to optimally utilize the available floor area. Hydroponic systems according to the invention may also be positioned in two or more levels above each other.

The individual nutrient solution pump 10 of the hydroponic system 1 of FIG. 1 has been replaced with a central nutrient solution storage tank with a common pump also denominated 10. The common pump 10 circulates nutrient solution from the central storage tank to each of the hydroponic systems 1 by means of nutrient solution conductors (also shown for one of the two lines of systems 1). Through the conductors 16, 17 the nutrient solution is distributed into each system as was explained in the above with reference to FIG. 1. After having been run through the space 4 of a hydroponic system 1, the solution is assembled via holes 18 (cf. FIG. 1) in the lower part of the lower panel to be returned to the central storage tank.

The nutrient solution is recirculated until the concentration of nutrients is too small after which further nutrients are added or the solution is replaced. Preferably, however, nutrients are added continuously to the nutrient solution. Sampling and adjustments to degree and nutrient concentrations can be made in the storage tank. The temperature, humidity, and pH level are measured constantly.

When harvesting the plants first the upper panel 2 including plants is removed from the remaining parts of the respective hydroponic system 1. The upper panel 2 is lifted up using for instance an arm with a chain drive, which may engage a chain or lug of the upper panel 2. Subsequently, the upper panel 2 is transported, e.g. via the same arm, to a harvest location in the form of central harvesting machinery. The harvesting machinery comprises automatic means for cutting off the roots of the plants from the bottom surface of the upper panel. The root cutting is carried out by means of one large knife guided along the lower side of the upper panel 2. Hereby, the plants are cut loose from the upper panel and can be collected for packing or further processing (e.g. berry-picking or the like).

1. A hydroponic system comprising
an upper panel adapted to carry plants to be grown in said hydroponic system, a lower panel arranged below said upper panel to form a space between said panels such as to allow for roots of said plants to extend through said upper panel into said space, said panels each comprising an oblique panel surface inclined downward from an apex or ridge, and
a nutrient solution dispenser arranged such as to allow for distribution of a nutrient solution between said upper and lower panels,
wherein
each of said panel surfaces is of such a shape that at least three, preferably at least four, tangential planes to each said panel surface can be defined, none of said tangential planes of each panel surface being parallel or coincident, and that at least the upper oblique panel surface is in the form of a cone or hemisphere, or comprises three or more distinct planes meeting in an apex.

2. A hydroponic system according to claim 1, the upper oblique panel surface of which having three or more distinct planes meeting in an apex, such that angles between the individual planes are at least 15°, preferably at least 25°, most preferred at least 35°.

3. A hydroponic system according to claim 1, wherein each said panel surface comprises four sides, lower edges of said four sides preferably forming a quadratic bottom plane.

4. A hydroponic system according to claim 3, wherein said four sides and bottom plane form a pyramid shape, an angle between each side in relation to said bottom plane preferably being within an interval of 10-50°, most preferred 30-40°.

5. A hydroponic system according to claim 1, wherein said upper and lower panels are of substantially similar shape and size and arranged such that said space between said panels is of a substantially constant height.

6. A hydroponic system according to claim 1, wherein said upper panel is in the form of a plate with holes or a net, a hole or mesh size preferably being smaller than 50 mm, more preferably 20 mm.

7. A hydroponic system according to claim 6, wherein said upper panel comprises a number of irregularities, such as steps or corrugations, adapted to provide frictional resistance of a grainy medium to be positioned on said upper panel to carry said plants.

8. A hydroponic system according to claim 1, wherein a medium, preferably an inert medium such as perlite, gravel or mineral wool, has been distributed over said upper panel.

9. A hydroponic system according to claim 1, wherein it is arranged side-by-side with a number of similar hydroponic systems according to any previous claim to form a hydroponic plant.

10. A method for harvesting of a hydroponic system, comprising the steps of:
providing a hydroponic system comprising a removable upper panel carrying plants to be harvested, a lower panel arranged below said upper panel to form a space between said panels, roots of said plants extending through said upper panel into said space,
removing said upper panel including said plants to be harvested from said hydroponic system,
transporting said upper panel to a harvesting location, and
cutting off said roots of said plants such that said plants are released from said upper panel, thereby harvesting said plants.

11. A method according to claim 10 for harvesting a hydroponic system according to any of the previous claims.

12. A hydroponic system comprising
an upper panel adapted to carry plants to be grown in said hydroponic system, a lower panel arranged below said upper panel to form a space between said panels such as to allow for roots of said plants to extend through said upper panel into said space, said panels each comprising a downwardly inclined panel surface;
a nutrient solution dispenser arranged such as to allow for distribution of a nutrient solution between said upper and lower panels;
means for aeroponic distribution of said nutrient solution in said space between said panels; and
means for continuous flow of said nutrient solution on an upper surface of said lower panel.

13. A hydroponic system according to claim 12, wherein said lower panel at an apex comprises an opening with a vessel to be filled with said nutrient solution, an atomizer, preferably ultrasound-driven, being positioned within said vessel allowing for aeroponic distribution of said nutrient solution in said space between said panels, preferably said vessel is arranged to also allow for continuous flow of said nutrient solution on an upper surface of said lower panel by means of overflow of said vessel.

14. (canceled)
